(19) United States
(12) Patent Application Publication
(10) Pub. No.: US 2018/0061257 A1
(43) Pub. Date: Mar. 1, 2018

(54) User-Navigable tutorial system for presenting information derived from source documents of factual situations

(71) Applicants: James Mintz, New York, NY (US); Irwin Chen, New York, NY (US); John Mintz, New York, NY (US); James Proctor, New York, NY (US); Ian Casewell, London (GB)

(72) Inventors: James Mintz, New York, NY (US); Irwin Chen, New York, NY (US); John Mintz, New York, NY (US); James Proctor, New York, NY (US); Ian Casewell, London (GB)

(21) Appl. No.: 15/692,318

(22) Filed: Aug. 31, 2017

Related U.S. Application Data
(63) Continuation of application No. 62/381,971, filed on Aug. 31, 2016.

(51) Int. Cl. G09B 5/06; G06F 9/44; G09B 19/00; G06F 3/0482; G06F 17/21

(52) U.S. Cl. CPC G09B 5/065; G06F 9/4446; G06F 17/212; G06F 3/0482; G09B 19/00

(57) ABSTRACT

Information via a tutorial or navigable environment where the navigable environment presents information to users via a navigable, layered user interface having various different information presentation schema or formats. rendering and presentation of an interactive, actionable, and/or navigable display of information is presented. A tutorial system renders and causes a user device to present a user-navigable series of categories associated with a specific topic based on underlying source documents via a user interface, and present sub-categories of information related to the specific topic as a user navigates various presented display elements.

### PRIORITY

This application claims priority to U.S. Provisional 62/381,971, filed Aug. 31, 2016, which is hereby incorporated by reference as if submitted in its entirety.

### SUMMARY

This application is related to electronic platforms and online computing environments, and, more specifically, to systems, methods, and devices for presenting information via a tutorial or navigable environment (e.g., an “online tutorial” or “online game-like interface”), where the navigable environment presents information to users via a navigable, layered user interface having various different information presentation schema or formats.

### BRIEF DESCRIPTION OF THE DRAWINGS

Various embodiments of the technology are disclosed in the following detailed description and accompanying drawings.

FIG. 1 is a block diagram illustrating a suitable computing environment for presenting an online tutorial.

FIG. 2 is a display diagram illustrating categories of information presented by a tutorial system.

FIGS. 3A-3B are display diagrams illustrating sub-categories of information presented by a tutorial system.

FIG. 4 is a display diagram illustrating endpoint information elements presented by the tutorial system.

FIG. 5 is a high-level block diagram showing an example architecture of a computer, which may represent any electronic device, any server, or any node within a cloud service, as described herein.

### DETAILED DESCRIPTION

Systems and methods for rendering and presentation of an interactive, actionable, and/or navigable display of information are described. In some embodiments, the systems and methods include a tutorial system that renders and causes a user device to present a user-navigable series of categories associated with a specific topic (e.g., “How to hide dirty money”) based on underlying source documents (e.g., documents that depict or are associated real-life situations or scenarios) via a user interface, and present sub-categories of information related to the specific topic as a user navigates (e.g., “selects”) various presented display elements.

The underlying source documents may include a variety of different documents, including news articles, books, multimedia programming (e.g., broadcasts, television programs, documentaries, and so on), reporting sources, and so on. For example, the systems and methods may identify and create a group of categories based on information provided by the underlying source documents (e.g., current or historical, or both), and present the group of categories in a certain navigable fashion and/or in a freeform manner (e.g., a non-directed presentation of the categories).

Thus, the systems and methods may render information in various formats to distill and/or provide a user-navigable interface, via which users may visualize, navigate, and perform actions within complex, dynamically changing scenarios or situations based on information from source documents, in order for the users to learn about the different scenarios or situations. For example, the systems and methods may present tutorials that visualize actions performed by and within criminal or nefarious enterprises, and users (e.g., law enforcement officials, investigators, and so on) may utilize such tutorials in order to gain knowledge about how to discover, prevent, counteract, or otherwise police such enterprises.

Various embodiments of the tutorial system will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

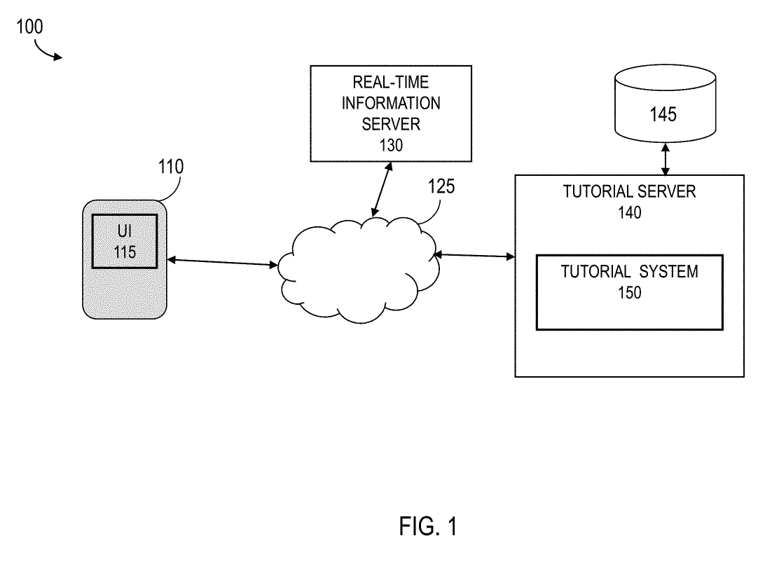

FIG. 1 is a block diagram illustrating a suitable computing environment 100 for presenting an online tutorial or game. The computing environment 100 includes a user device 110, such as a laptop computer, desktop computer, tablet, smart phone, and so on, which presents information and receives input from the user via a user interface 115, such as an application or browser running on the user device 110.

The user device 110 receives and transmits information over a network 125 with a tutorial server 140, which includes a tutorial system 150 that is configured to render and cause the user interface 115 to present tutorials and/or gamified displays of information on a variety of topics, such as topics associated with financial strategies, topics associated with real-life situations, scenarios, or occurrences, and so on. For example, the tutorial system 150 may present different categories of information associated with real-life or mimicked situations for “hiding money” and/or “finding money.”

The tutorial system 150, via the tutorial server 140, may access information, data, and so on from one or more local databases 145 and/or via real-time information servers 130 over the network. For example, when generating tutorials depicting real-life or representative situations for users, the tutorial system 150 may access rendering layout information, templates, and/or instructions from local database 145 and/or content about the situations from local database 145. Further, the tutorial system 140 may access additional information from the real-time information server 130, such as information from news articles or sites, information from microblogs or other social network services, information from various information portals (e.g., Wikipedia), and so on.

Thus, in some embodiments, the tutorial system 150 renders a user-navigable tutorial of information for a topic using information accessed and retrieved from local databases 145 and/or other sources, such as the real-time information server 130, over the network 125, and causes the user interface 115 to present the rendered tutorial to a user associated with the user device 110.

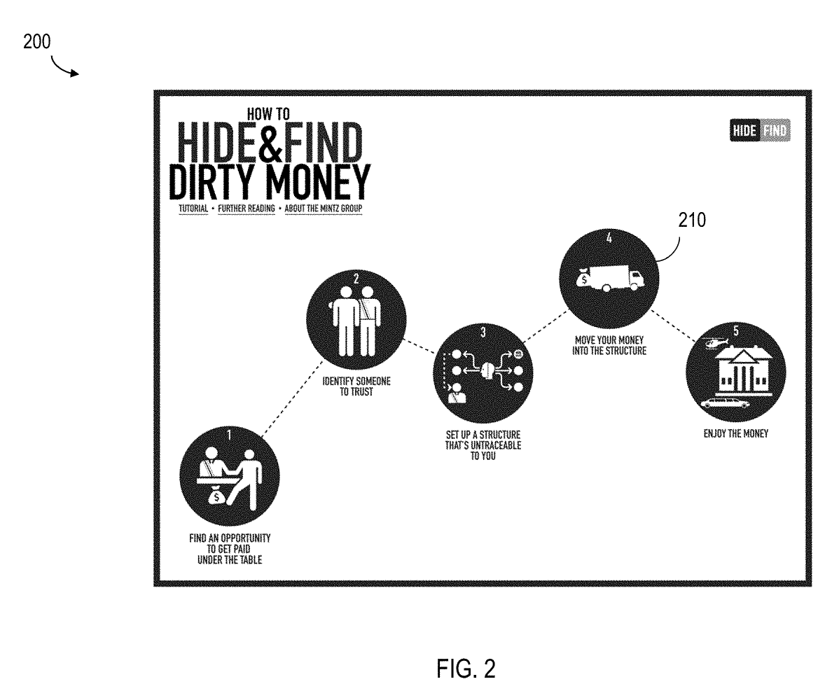

As described herein, the tutorial system 150 renders tutorials about different topics using different layout formats. FIG. 2 is a display diagram 200 illustrating categories of information presented by a tutorial system. As depicted in the Figure, a topic entitled “How to Hide and Find Dirty Money” presents multiple display elements 210 representing categories of information in a linear layout format.

For example, moving left to right across the user interface 200, the tutorial system 150 may present a first display element representing “finding an opportunity to get paid under the table”,” a second display element representing “identifying someone to trust,” a third display element representing “set up a structure that's untraceable to you,” a fourth display element representing “move your money into the structure,” and a fifth display element “enjoy the money.”

As depicted, the various display elements 210 are presented in a linear layout format, which may assist a user in navigating between the categories, such that the tutorial presents the information in a logical sequence of user selections. A user may navigate the tutorial via the logical sequence, or randomly interact with the categories. For example, the linear layout format displays the second display element representing “identifying someone to trust,” before (from left to right) the third display element representing “set up a structure that's untraceable to you is displayed, which may assist the user in obtaining information about how to identify a trustworthy person before obtaining information about how to use that person when building an untraceable structure.

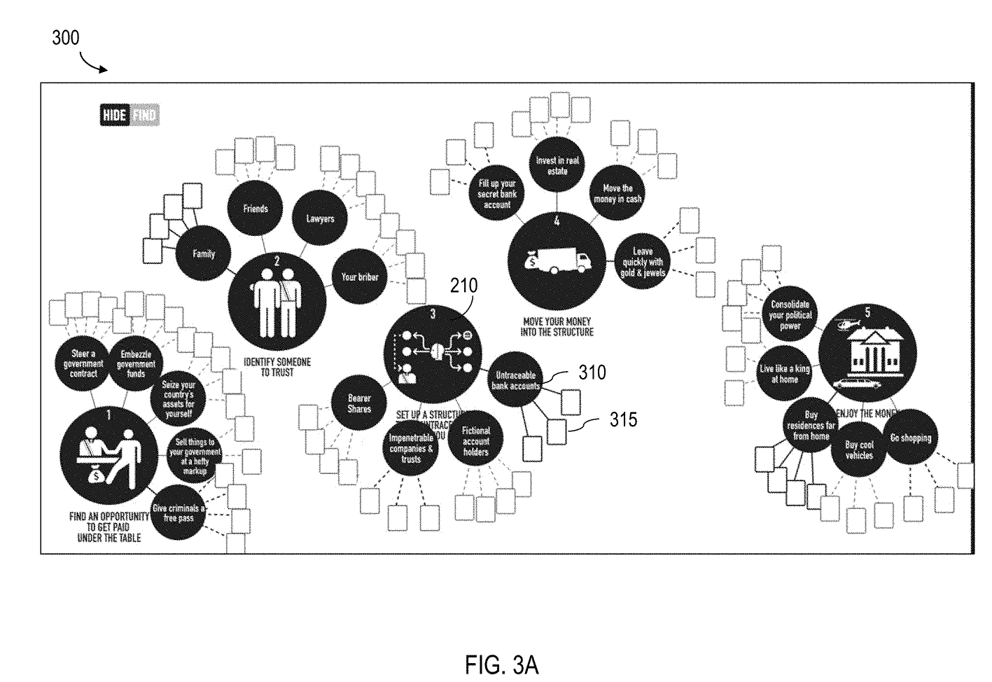

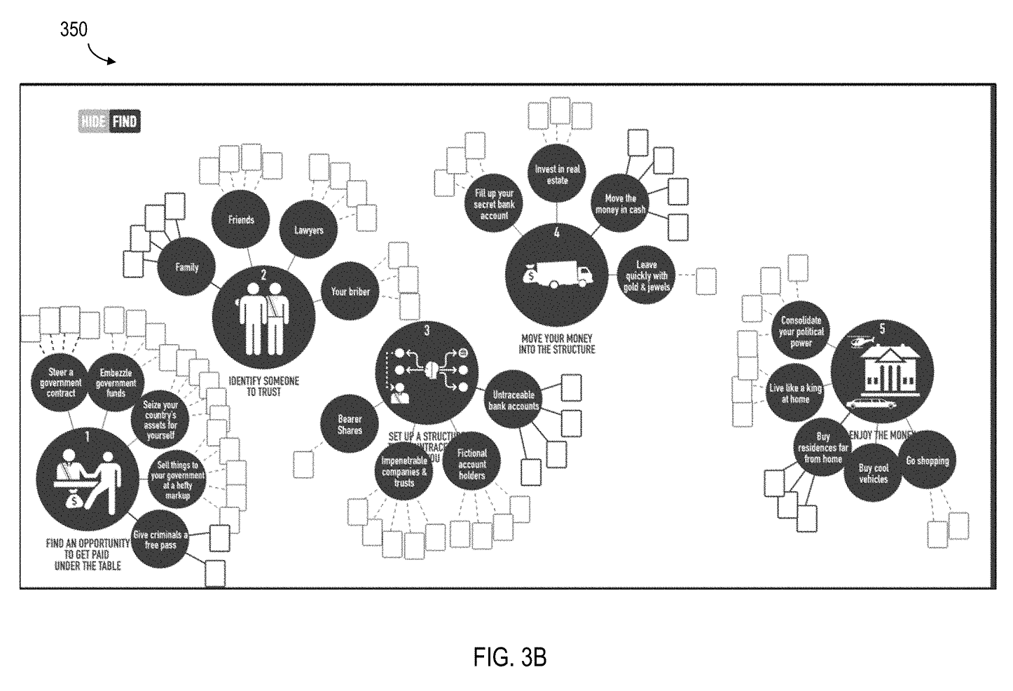

FIGS. 3A-3B depict the presentation of display elements 310 for subcategories of information, such as information presented after the display elements 210 are selected by a user. For example, upon a user-selection of the display element 210 for “set up a structure untraceable to you,” in FIG. 3A, the tutorial system 150 causes the user interface to present display elements 310 for the sub-categories of information associated with that category: “bearer shares,” impenetrable companies and trusts,” “fictional account holders,” and “untraceable bank accounts.”

In some embodiments, the tutorial system 150 causes the display elements 310 to be presented in a non-linear layout format, such as elements that surround or are linked as nodes to the display element 210. For example, the non-linear layout may indicate a direct connection between the sub-category and category, without also indicating a hierarchy or directed navigation path between sub-categories.

FIG. 3A also presents display elements 315 associated with endpoint, situation, and/or scenario information, such as content presenting information associated with real-life scenarios, situations, enterprises, groups (e.g., companies, government, factions, and so on), actors (e.g., people), and so on.

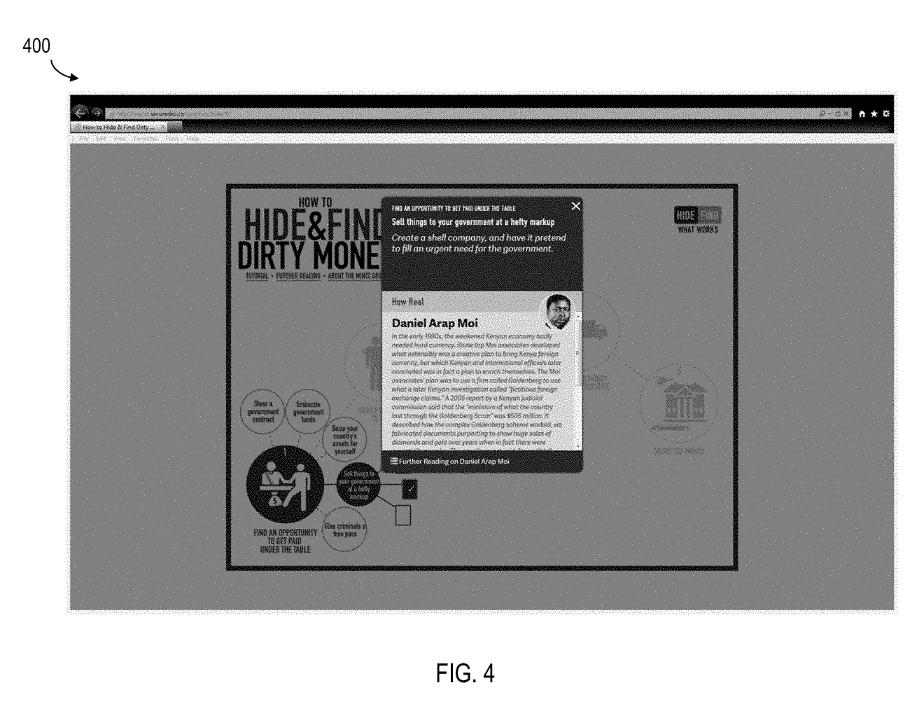

For example, FIG. 4 depicts endpoint information display elements 315 presented by the tutorial system 150. In FIG. 4A, the user interface 400 presents a navigation path that includes the selected display element 210 for the category “find an opportunity to get paid under the table,” the selected display element 310 for the sub-category “sell things to your government at a hefty markup,” and the selected display element 315 associated with endpoint information for “creating a shell company,” as well as information describing the real-life actor Daniel Arap Moi (who performed actions similar to those as depicted in the navigation path), and other information that may be retrieved and presented by the tutorial system 150.

Thus, in some embodiments, the tutorial system 150 renders a user-navigable pattern of categories or groupings from various disparate or seemingly unrelated fact patterns, scenarios, real-life examples, and other information derived from underlying source documents and other sourced information.

Of course, in addition to the examples described herein, the tutorial system 150 may present various different types of information, such as other text or graphics, multimedia information, including audio presentations, video presentations, and so on. For example, the tutorial system 150 may present voiceovers or other audio guide information along with the visual depictions of categories and/or sub-categories, such as an audio version of the following text (which may be presented in parts as a user navigates through a presented tutorial:

“This visualization draws from the cases of 30 presidents and other top government officials from around the world who are the subject of widely publicized allegations that they enriched themselves while in office. We dug into how corrupt officials hide their dirty money, and we noticed distinct patterns in how they do it, and in how investigators FIND the money these officials hide away. We hope these insights help investigators—law enforcement, journalists, and NGOs—trace and recover misappropriated public assets.

Our visualization shows the five steps it takes to hide dirty money. As you take each step, we ask you to think like you're a public official with a payoff coming your way.

We give you options to choose from around each step. For example, the third step—Set Up A Structure—lets you choose bearer shares to hide your new wealth, or untraceable bank accounts, or offshore front companies, etc.

And each option opens up more choices for you—scenarios drawn from specific ways that our 30 officials hid their assets. Just flip over the cards to see how each scenario is real.

Finally we visualize how these hidden assets were uncovered based on prosecutions, lawsuits, and reports by public agencies, all of which are linked to an all of which you can therefore review for yourself In some instances the public official has denied any wrongdoing, and that may be true as to him. But in all of these cases, the money is there and we show the specific investigative tactics that worked, busting the flows of dirty money at specific points in the 5-step process.

If you want more help getting around our visualization, click on the Tutorial link at any time. Otherwise, you're ready to start hiding dirty money, and finding it.”

Thus, the presented tutorials may relate or associate a navigation path through various categories and sub-categories of information with a real-life situation, event, or actor, enabling users to map the actions to real-life events and actions, and learn how to uncover and/or discover future attempts or occurrences of such action, among other benefits.

Suitable Computing System

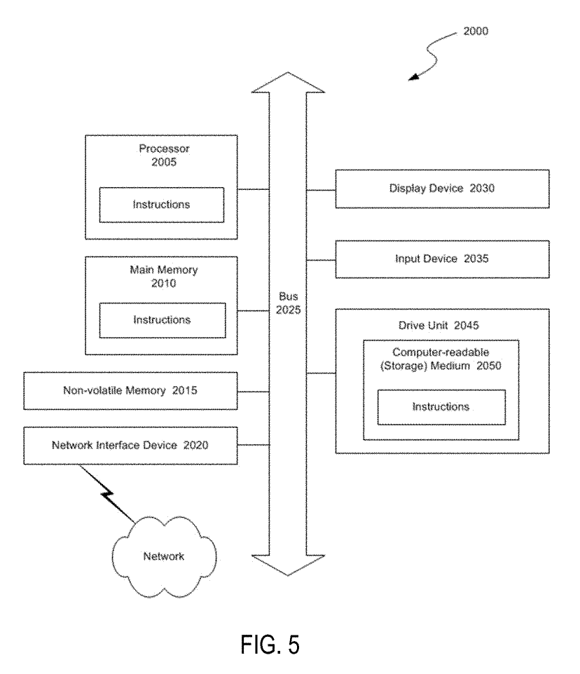

FIG. 5 shows a diagrammatic representation of a computer system 2000 on which any system or device disclosed in the embodiments can be implemented. The computer system 2000 generally includes a processor 2005, main memory 2010, non-volatile memory 2015, and a network interface device 2020. Various common components (e.g., cache memory) are omitted for illustrative simplicity. The computer system 2000 is intended to illustrate a hardware device on which any of the components and methods described above can be implemented. The computer system 2000 can be of any applicable known or convenient type. The components of the computer system 2000 can be coupled together via a bus 2025 or through some other known or convenient device.

The processor 2005 may be, for example, a conventional microprocessor such as an Intel Pentium microprocessor or Motorola power PC microprocessor. One of skill in the relevant art will recognize that the terms “computer system-readable (storage) medium” or “computer-readable (storage) medium” include any type of device that is accessible by the processor.

The memory 2010 is coupled to the processor 2005 by, for example, a bus 2025 such as a PCI bus, SCSI bus, or the like. The memory 2010 can include, by way of example but not limitation, random access memory (RAM), such as dynamic RAM (DRAM) and static RAM (SRAM). The memory 2010 can be local, remote, or distributed.

The bus 2025 also couples the processor 2005 to the non-volatile memory 2015 and drive unit 2045. The non-volatile memory 2015 is often a magnetic floppy or hard disk, a magnetic-optical disk, an optical disk, a read-only memory (ROM), such as a CD-ROM, EPROM, or EEPROM, a magnetic or optical card, SD card, or another form of storage for large amounts of data. Some of this data is often written, by a direct memory access process, into memory during execution of software in the computer system 2000. The non-volatile memory 2015 can be local, remote, or distributed. The non-volatile memory can be optional because systems can be created with all applicable data available in memory. A typical computer system will usually include at least a processor, memory, and a device (e.g., a bus) coupling the memory to the processor.

Software is typically stored in the non-volatile memory 2015 and/or the drive unit 2045. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory 2010 in this disclosure. Even when software is moved to the memory for execution, the processor will typically make use of hardware registers to store values associated with the software, and local cache. Ideally, this serves to speed up execution. As used herein, a software program is assumed to be stored at any known or convenient location (from non-volatile storage to hardware registers) when the software program is referred to as “implemented in a computer-readable medium”. A processor is considered to be “configured to execute a program” when at least one value associated with the program is stored in a register readable by the processor.

The bus 2025 also couples the processor to the network interface device 2020. The interface can include one or more of a modem or network interface. It will be appreciated that a modem or network interface can be considered to be part of the computer system 2000. The interface can include an analog modem, isdn modem, cable modem, token ring interface, satellite transmission interface (e.g., “direct PC”), or other interfaces for coupling a computer system to other computer systems. The interface can include one or more input and/or output devices 2035. The I/O devices can include, by way of example but not limitation, a keyboard, a mouse or other pointing device, disk drives, printers, a scanner, speaker, DVD/CD-ROM drives, disk drives, and other input and/or output devices, including a display device. The display device 2030 can include, by way of example but not limitation, a cathode ray tube (CRT), liquid crystal display (LCD), LED display, a projected display (such as a heads-up display device), a touchscreen or some other applicable known or convenient display device. The display device 5330 can be used to display text and graphics.

In operation, the computer system 2000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory 2015 and/or drive unit 2045 and causes the processor to execute the various acts required by the operating system to input and output data and to store data in the memory, including storing files on the non-volatile memory 2015 and/or drive unit 2045.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device that manipulates and transforms data represented as physical (electronic) quantities within the computer system's registers and memories into other data similarly represented as physical quantities within the computer system memories or registers or other such information storage, transmission, or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the computer system operates as a standalone device or may be connected (e.g., networked) to other computer systems. In a networked deployment, the computer system may operate in the capacity of a server or a client computer system in a client-server network environment, or as a peer computer system in a peer-to-peer (or distributed) network environment.

The computer system may be a server computer (e.g., a database server), a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any computer system capable of executing a set of instructions (sequential or otherwise) that specify actions to be taken by that computer system.

While the computer system-readable medium or computer system-readable storage medium 2050 is shown in an exemplary embodiment to be a single medium, the term “computer system-readable medium” and “computer system-readable storage medium” should be taken to include a single medium or multiple media (e.g., a centralized or distributed database, and/or associated caches and servers) that store the one or more sets of instructions. The term “computer system-readable medium” and “computer system-readable storage medium” shall also be taken to include any medium that is capable of storing, encoding or carrying a set of instructions for execution by the computer system and that cause the computer system to perform any one or more of the methodologies of the presently disclosed technique and innovation.

In general, the routines executed to implement the embodiments of the disclosure, may be implemented as part of an operating system or a specific application, component, program, object, module, or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of computer system or computer-readable media used to actually effect the distribution.

Further examples of computer system-readable storage media, computer system-readable media, or computer-readable (storage) media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), SD cards, among others.

Unless the context clearly requires otherwise, throughout the description and the claims, the words “comprise”, “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein”, “above”, “below”, and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A method for the presentation of a user-navigable environment via at least one display, the method, with at least one computing device communicatively coupled to the at least one display, comprising:
retrieving one or more pieces of information based on at least one user request;
displaying the one or more pieces of information;
detecting, by the environment, at least one user action; and
displaying one or more sub-categories of information in response to the user action;
wherein the one or more pieces of information are retrieved from one or more underlying source documents; and
wherein the displaying of the one or more pieces of information comprising rendered in a certain format based on a type of the one or more underlying source documents.

2. The method of claim 1, wherein the information is presented via a layered user interface.

3. The method of claim 1, wherein the user-navigable environment is an on-line tutorial.

4. The method of claim 1, wherein the rendered one or more pieces of information dynamically change over time based on different scenarios or situations.

5. The method of claim 1, wherein the one or more pieces of information are retrieved from a local database, a real-time information database, or both.

6. A system for presenting a user-navigable environment, comprising:
one or more processors; and
at least one computer readable medium communicatively coupled to the one or more processors and configured to store executable computer instructions when executed cause the one or more processors to:
retrieve one or more pieces of information based on at least one user request;
display the one or more pieces of information;
detect, by the environment, at least one user action; and
display one or more sub-categories of information in response to the user action;
wherein the one or more pieces of information are retrieved from one or more underlying source documents; and
wherein the displaying of the one or more pieces of information comprising rendered in a certain format based on a type of the one or more underlying source documents.

7. The system of claim 6, wherein the information is presented via a layered user interface.

8. The system of claim 6, wherein the user-navigable environment is an on-line tutorial.

9. The system of claim 6, wherein the rendered one or more pieces of information dynamically change over time based on different scenarios or situations.

10. The system of claim 6, wherein the one or more pieces of information are retrieved from a local database, a real-time information database, or both.

11. A non-transitory computer readable medium storing computer-executable instructions, the instructions, when executed, cause a processor to:
retrieve one or more pieces of information based on at least one user request;
displaying the one or more pieces of information;
detecting, by the environment, at least one user action; and
display one or more sub-categories of information in response to the user action;
wherein the one or more pieces of information are retrieved from one or more underlying source documents; and
wherein the displaying of the one or more pieces of information comprising rendered in a certain format based on a type of the one or more underlying source documents.

12. The medium of claim 11, wherein the information is presented via a layered user interface.

13. The medium of claim 11, wherein the user-navigable environment is an on-line tutorial.

14. The medium of claim 11, wherein the rendered one or more pieces of information dynamically change over time based on different scenarios or situations.

15. The medium of claim 11, wherein the one or more pieces of information are retrieved from a local database, a real-time information database, or both.
